(19) United States
(12) Patent Application Publication
(10) Pub. No.: US 2026/0160488 A1
(43) Pub. Date: Jun. 11, 2026

(54) CARBON DIOXIDE COMPRESSION SYSTEM AND METHOD WITH MULTIPHASE COMPRESSION AND SUPERCRITICAL PUMP

(71) Applicant: IFP ENERGIES NOUVELLES, RUEIL-MALMAISON (FR)

(72) Inventor: Victor MOENNE LOCCOZ, RUEIL-MALMAISON CEDEX (FR)

(73) Assignee: IFP ENERGIES NOUVELLES, RUEIL-MALMAISON (FR)

(21) Appl. No.: 18/878,499

(22) PCT Filed: Jun. 9, 2023
(86) PCT No.: PCT/EP2023/065509

§ 371 Date: Dec. 23, 2024

(30) Foreign Application Priority Data
Jun. 24, 2022 (FR) 2206336

(51) Int. Cl. F25J 1/00; F04D 25/16; F25J 1/02

(52) U.S. Cl. CPC F25J 1/0027; F25J 1/0257; F04D 25/163; F25J 2230/30; F25J 2235/80; F25J 2270/90

(57) ABSTRACT

The invention concerns a carbon dioxide compression method comprising at least the following steps:
a) compressing (Comp) the fluid to a pressure (P1) greater than 8 bar and strictly less than 50 bar,
b) cooling (Ref1) the compressed fluid to a temperature (T1′) of between −50° C. and 15° C., so as to partly liquefy the fluid, the gas volume fraction of the fluid ranging between 1% and 99%,
c) carrying out multiphase compression (PP) of the cooled compressed fluid to a pressure (P3) strictly below the critical pressure of the fluid,
d) preferably cooling (Ref2) the fluid from multiphase compression (PP) so as to totally liquefy at least the carbon dioxide,
e) compressing (PSP) the fluid so that the fluid pressure (P4) exceeds the critical point of the fluid.

The invention also concerns a transport and storage method, as well as a compression system for carbon dioxide.

### FIELD OF THE INVENTION

The invention concerns the field of compression of carbon dioxide for transport and sequestration (storage) thereof.

Within the context of the fight against global warming, significant efforts are needed to reduce the amount of carbon dioxide (CO₂) released to the atmosphere. Developing CO₂ capture and storage facilities is one of the most promising ways to drastically reduce emissions from the most polluting industries and to enable a soft energy transition. These systems aim to capture and process the CO₂ emitted by these industries, and to sequester it underground, in suitable geological layers or in artificial reservoirs.

### BACKGROUND OF THE INVENTION

Known techniques for storing captured carbon dioxide consist in compressing the carbon dioxide in gas form, then in cooling it so as to convert it to a liquid phase or a supercritical phase for transport and storage thereof.

Patent application WO-2011/101,296 concerns a method of compressing carbon dioxide by maintaining it in the gas phase. The gas pressure is increased in successive compression stages until the critical pressure is exceeded. The flow is then cooled to the desired temperature for transport.

Patent application JP-2010/266,154 concerns a method of compressing carbon dioxide in the gaseous state to a pressure strictly below the critical pressure. The carbon dioxide is then cooled to a totally liquid state. It is subsequently compressed in the liquid state until the critical pressure is reached.

For these methods, carbon dioxide requires a very high level of purity: impurities may, on the one hand, generate a yield loss and/or deterioration of single-phase compression systems (liquid or gas), and on the other hand modify the phase change characteristics of the fluid (notably the critical point of transition to the supercritical state).

Patent application FR-2,891,609 (US-2009/075,219) filed by the applicant, which comprises a method for carbon dioxide capture and compression using a multiphase pump, is also known.

However, in this method, transition to the supercritical state occurs within the multiphase pump, which is not optimal for the operation of the pump and the method.

### SUMMARY OF THE INVENTION

The aim of the invention is to provide a method and a system for compressing a fluid comprising carbon dioxide and likely to contain a high level of impurities (preferably at least 5% impurities), including noncondensible gas, with an improved energy efficiency.

The invention therefore concerns a method for compressing a fluid comprising at least 80% carbon dioxide, the method comprising at least the following steps:
a) compressing the fluid in one or more compression stages to a pressure greater than 8 bar and strictly less than 50 bar,
b) cooling the compressed fluid to a temperature of between −50° C. and 15° C., the fluid pressure being maintained greater than 8 bar and strictly less than 50 bar, so as to partly liquefy the carbon dioxide of the fluid, the gas volume fraction of the fluid ranging between 1% and 99%,
c) carrying out multiphase compression of the cooled compressed fluid to a pressure strictly below the critical pressure of the fluid, multiphase compression being carried out in one or more multiphase compression stages,
d) preferably cooling the fluid from the multiphase compression so as to totally liquefy at least the carbon dioxide of the fluid,
e) compressing the fluid so that the fluid pressure exceeds the critical point of the fluid, preferably to a temperature below 60° C.

Advantageously, the fluid is compressed in step a) using a single integrally-geared compressor.

Preferably, between at least two compression stages in step a), the fluid is cooled so as to be maintained at a temperature of between 10° C. and 100° C.

Advantageously, after cooling the fluid after at least one compression stage in step a), the fluid in the liquid state is separated from the fluid in the gaseous state.

According to a configuration of the invention, multiphase compression is carried out using a helicoaxial type multiphase pump.

Preferably, multiphase compression is carried out in several multiphase compression stages and the fluid is preferably cooled by coolers, preferably water coolers, between at least two multiphase compression stages.

According to one implementation of the invention, the fluid is carbon dioxide comprising between 0% and 20% impurities.

According to a variant of the invention, after step d) of cooling the fluid from the multiphase compression stage, when the impurities contain noncondensible gas, the fluid is treated to reduce the gas volume fraction to a value below 5%, preferably by gas/liquid separation.

The invention also concerns a method for transport and storage of a fluid comprising at least 80% carbon dioxide, wherein the fluid is compressed according to the compression method as described above, then the fluid is transported to a storage site and it is stored in a storage reservoir of the storage site.

The invention also concerns a system for compressing a fluid comprising at least 80% carbon dioxide, the compression system successively comprising at least one compression means, a first cooling means for partly liquefying the fluid, a multiphase pump, a second cooling means for totally liquefying the fluid, and a supercritical pump, the compression means preferably consisting of a single integrally-geared compressor, the system being suited for implementing the method as described above.

Advantageously, the system comprises several compression means, and third cooling means, possibly followed by gas/liquid separators, are preferably arranged between the compression means.

Preferably, the system comprises at least one gas/liquid separation means preferably positioned between the second cooling means and the supercritical pump.

### BRIEF DESCRIPTION OF THE FIGURES

Other features and advantages of the method and/or of the system according to the invention will be clear from reading the description hereafter of embodiments given by way of non-limitative example, with reference to the accompanying figures wherein:

FIG. 1 shows a fluid compression system according to the invention,

FIG. 2 illustrates a fluid compression method according to the invention,

FIG. 3 compares the thermodynamic path of the compression method according to the invention (path c)) with the thermodynamic paths of the compression methods of the prior art (paths (a) and (b)), and

FIG. 4 illustrates various gas/liquid saturation curves for various fluids containing carbon dioxide.

### DETAILED DESCRIPTION OF THE EMBODIMENTS

The present invention is a link in the CO₂ capture and storage chain referred to as “conditioning” or “compression”. The aim is to bring the captured CO₂ from its capture conditions (for example, pressure ranging between 1 and 3 bar (between 0.1 and 0.3 MPa), preferably between 1 and 1.5 bar (0.1 to 0.15 MPa), and temperature ranging between 10° C. and 50° C., preferably between 10° C. and 35° C., while the carbon dioxide may contain various types and levels of impurities depending on where it was captured), to supercritical conditions (pressure above supercritical pressure, for example 74 bar, i.e. 7.4 MPa, for pure or nearly pure carbon dioxide, and temperature ranging between 0° C. and 60° C.) for transport and sequestration thereof.

To achieve this goal, the invention concerns a novel CO₂ compression method and system comprising notably a multiphase pump. It allows to compress CO₂ despite the presence of a high level of impurities (above 5 vol. %). This method is also optimized in terms of energy efficiency according to the flow resulting from the capture.

Impurities are understood to be any molecule distinct from a CO₂ molecule. Impurities may be solid, liquid or gaseous particles: they may notably concern noncondensible gases such as dinitrogen or dihydrogen, for example.

What is understood by “pure or nearly pure carbon dioxide” is less than 1% impurities in the carbon dioxide.

The level of impurities is understood to be the volume fraction of impurities in the fluid.

A noncondensible gas is understood to be a gas for which the liquefaction temperature is a cryogenic temperature, for example below −150° C.

The critical point is the point corresponding to the pressure and temperature at which the fluid transitions into the supercritical state; the critical temperature is the minimum temperature from which the fluid can transition to the supercritical state.

A multiphase pump is understood to be a device for compressing a fluid flowing into the compression device in multiphase form with at least one gas phase and at least one liquid phase. The multiphase pump may notably correspond to the helicoaxial multiphase pumps described in patent applications FR-2,665,224 (U.S. Pat. No. 5,375,976), FR-2,899,944 (US-2009/311,094) or FR-3,010,463 (US-2016/222,977). The multiphase pump can then comprise one or more multiphase compression stages. The multiphase pump can comprise at least one movable wheel rotating about an axis and mounted in a casing, and at least one fixed wheel secured to the casing, said movable wheel comprising a hub provided with at least two blades so as to form at least two channels delimited by the hub, the casing and two of said blades, and said channels have a centrifugal part. The multiphase pump can also correspond to a gear pump or any other type of multiphase pumping technology.

A supercritical pump is understood to be a device for compressing a fluid flowing in and leaving in the supercritical state, or flowing into the pump in the liquid phase and leaving the supercritical pump in the supercritical state. Without limitation to these examples, the technologies used can be as follows: diaphragm pump, gear pump, canned motor pump, peristaltic pump.

The multiphase pump can consist of one or more multiphase stages followed by one or more non-helicoaxial stages so as to allow a fluid in the supercritical state at the multiphase pump outlet. The multiphase pump is thus also a supercritical pump.

The invention concerns a method for compressing a fluid comprising at least 80% carbon dioxide. In other words, the fluid can be carbon dioxide with between 0% and 20% impurities.

Advantageously, the fluid can comprise between 5% and 20% impurities.

As it enters the compression process, the fluid can have a pressure of between 1 and 3 bar (0.1 to 0.3 MPa), preferably between 1 and 1.5 bar (0.1 to 0.15 MPa), i.e. a pressure close to the atmospheric pressure, and a temperature of between 10° C. and 50° C., preferably between 10° C. and 35° C.

According to the invention, the method comprises at least the following steps:
a) compressing the fluid in one or more compression stages to a pressure greater than 8 bar (0.8 MPa) and strictly less than 50 bar (5 MPa). This pressure range is important for improvement of the energy efficiency of the method. Indeed, below a pressure of 8 bar (0.8 MPa), the liquefaction temperatures of carbon dioxide are less than −50° C. Therefore, cooling for partial carbon dioxide liquefaction requires a significant energy consumption. Besides, above 50 bar (5 MPa), using multiphase compression loses its interest because the pressure would then be too close to the critical pressure (74 bar, i.e. 7.4 MPa, for pure or nearly pure carbon dioxide).

Using several compression stages allows the overall compression efficiency to be improved.

Preferably, the fluid can be compressed to a pressure ranging between 10 and 30 bar (1 to 3 MPa), and more preferably between 12 and 20 bar (1.2 to 2 MPa), these value ranges providing better reduction of the energy consumption of the method.

At the outlet of the last compression stage, the temperature of the fluid can range between 10° C. and 100° C. for example.
b) cooling the compressed fluid to a temperature of between −50° C. and 15° C., the fluid pressure being maintained, during cooling, substantially at the pressure of step a) or by slightly varying while remaining greater than 8 bar (0.8 MPa) and strictly less than 50 bar (5 MPa), so as to partly liquefy the carbon dioxide of the fluid, the gas volume fraction of the fluid ranging between 1% and 99% at cooling outlet. Preferably, the compressed fluid can be cooled to a temperature greater than −50° C. and strictly less than 0° C., which allows the energy consumption of the method to be further reduced.

What is understood by partial liquefaction is that the fluid is multiphase and it comprises a portion in gas form and another portion in liquid form, i.e. the fluid is not totally liquefied, a part of the fluid remaining in gas form (at least 1% for example). The gas volume fraction of the fluid can advantageously range between 50% and 95%, more preferably between 60% and 90%, these proportions allowing the energy performances of the method to be improved.
c) carrying out multiphase compression of the cooled compressed fluid to a pressure strictly below the critical pressure of the fluid, using a multiphase pump for example. The fluid therefore remains in the multiphase state with a gaseous portion and a liquid portion, which allows the multiphase pump efficiency to be improved. Multiphase compression can be carried out in one or more multiphase compression stages, depending on the inlet and outlet pressures of the multiphase pump notably. At the multiphase compression outlet, the temperature of the fluid can range between 0° C. and 60° C. Using multiphase compression allows to accept carbon dioxide with a high level of impurities: for example, the fluid can comprise at least 5% impurities, which is not the case of the systems and methods of the prior art where compression is only single-phase. Thus, the method of the invention can accept the gas as captured, without requiring pretreatment of the fluid to remove impurities. This allows to simplify the global method and to reduce the overall carbon dioxide storage cost.
d) preferably cooling the fluid from multiphase compression so as to totally liquefy at least the carbon dioxide of the fluid. In other words, step d) is optional. By carrying out step d) at cooling outlet, the carbon dioxide of the fluid is entirely in the liquid state, and the impurities can be liquid or gaseous. Transition to the liquid state of the carbon dioxide facilitates the next step consisting in bringing the fluid to the supercritical state. Thus, as the next step is facilitated, the energy performances of the method are also improved.
e) compressing the fluid so that the fluid pressure exceeds the critical point (critical pressure) of the fluid, preferably using a supercritical pump. Transition to the supercritical state in the supercritical pump is facilitated when the carbon dioxide has been previously totally liquefied. Preferably, at the supercritical pump outlet, the temperature of the fluid is below 60° C. so as to limit thermal losses for subsequent transport and/or storage of the fluid.

Advantageously, in step a), the fluid can be compressed using integrally-geared compressors, this type of compressor being suited for compression of a gaseous fluid.

According to a variant of the invention, between at least two compression stages of step a), the fluid can be cooled, using a cooling means such as a heat exchanger, so as to be maintained at a temperature of between 10° C. and 100° C. Cooling can be performed by a direct or indirect heat exchanger for example. Cooling the fluid before the next compression stage prevents the fluid from reaching too high temperatures, which limits later cooling of the fluid and enables the various compression means (notably compressors) of each stage to operate at a temperature close to the operating temperature, thus close to their nominal efficiencies.

In this variant, the gaseous and liquid parts of the fluid can preferably be separated after cooling the fluid after at least one compression stage of step a).

Thus, when the fluid is cooled after a compression stage, the liquid contained in the fluid can be advantageously separated after this cooling step. Indeed, while cooling the fluid, the amount of liquid increases by condensation, the separation step can therefore be useful after cooling, so as to eliminate as much as possible the liquid before the next compression stage, and thus to best protect the next compression means. For example, the liquid contained in the fluid can be separated after each cooling performed after each compression stage, so as to avoid damage to the compression means of the next stage.

Advantageously, the multiphase compression of step c) can be carried out with a multiphase pump of helicoaxial type. This type of pump provides good compression efficiency with possible high variations of the gas fraction in the fluid.

According to an implementation of the invention, during the multiphase compression of step c), the fluid can be cooled by coolers, preferably water coolers, between at least two multiphase compression stages. Temperature increase is thus limited, which allows to avoid too high temperatures and associated thermal losses. This also allows to increase the fluid level at the inlet of the next multiphase compression stages.

Advantageously, the fluid can be carbon dioxide comprising between 0% and 20% impurities, preferably between 5% and 20% impurities. It is therefore possible to use the compression method directly after capture, without having to pretreat the fluid to limit the level of impurities to a very small fraction (less than 5%).

Preferably, after step d) of cooling the fluid from multiphase compression, when the impurities contain noncondensible gases (notably with a volume fraction of noncondensible gases above 5%), the fluid can be treated to reduce the gas volume fraction to a value below 5%, preferably, by gas/liquid separation.

For example, to carry out this treatment intended to reduce the gas volume fraction to a value below 5%, the fluid in the gas state can be separated from the fluid in the liquid state after the cooling step of step d): the gas contained in the fluid can be separated, notably the noncondensible gas, so as to limit the proportion of gas in the fluid and thus to optimize the operation of the supercritical pump.

The invention also concerns a method for transport and storage of a fluid comprising at least 80% carbon dioxide (preferably, the fluid is carbon dioxide with 5% to 20% impurities), wherein the fluid is compressed according to the compression method as described above, then the fluid is transported to a storage site and it is stored in a storage reservoir of the storage site. The storage reservoir can be an artificial reservoir or a natural reservoir such as a geological reservoir, for example a reservoir that contained oil or natural gas. By means of the compression method of the invention, the fluid can only be pretreated by gas/liquid separators, which simplifies pretreatment, allows to reduce the transport and storage cost, and limits energy consumption.

The invention further concerns a system for compressing a fluid comprising at least 80% carbon dioxide (preferably, the fluid is carbon dioxide with 5% to 20% impurities). This compression system successively comprises at least one compression means (notably a compressor) for compressing the fluid according to step a), a first cooling means such as a heat exchanger for partly liquefying the fluid according to step b), a multiphase pump for step c), a second cooling means such as a second heat exchanger for totally liquefying the fluid in order to carry out step d), and a supercritical pump for carrying out step e).

The system is thus suited for implementing the compression method and the transport and storage method according to any one of the variants or variant combinations described above.

Preferably, the various compression phases of step a) can be carried out using a single integrally-geared compressor. In other words, the system can comprise a single integrally-geared compressor for compressing the fluid according to step a), whether it comprises one or more compression phases.

Advantageously, the system can comprise several compression means to optimize the compression energy efficiency and thus perform several compression stages in step a).

Preferably, third cooling means can be arranged between the compression means (in the direction of flow of the fluid) in order to cool the fluid to a suitable temperature (10° C. to 100° C. for example) before the next compression means, so as to improve the efficiency of each compression means.

More preferably yet, at least one of the third cooling means and preferably each third cooling means can be followed by a gas/liquid separator to eliminate the liquid contained in the fluid (in the direction of flow of the fluid). Thus, the gas/liquid separator is positioned between a third cooling means and a compression means so as to eliminate the liquid that may have condensed in the third cooling means before the fluid reaches the next compression means. Eliminating the liquid thus prevents damage to the next compression means and improves the service life thereof.

According to a variant of the invention, the system can comprise at least one gas/liquid separation means (a second gas/liquid separator) for eliminating the gas contained in the fluid, the gas/liquid separation means being preferably positioned between the second cooling means and the supercritical pump (in the direction of flow of the fluid). Eliminating the gas contained in the fluid, which may come from other gases than carbon dioxide, and notably noncondensible gases, allows the operation of the supercritical pump to be improved. The gas/liquid separation means is preferably designed in such a way that, at the outlet of the gas/liquid separation means, the gas volume fraction of the fluid is below 5%, which allows the performances of the supercritical pump to be improved.

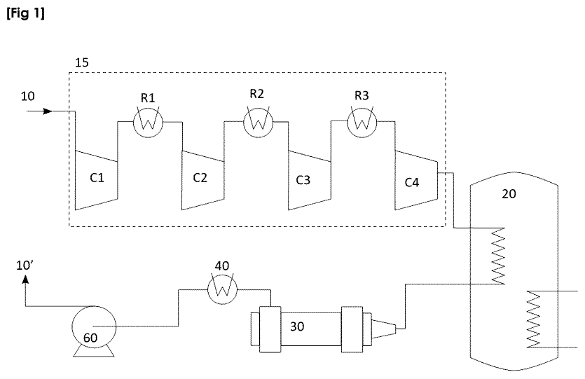

FIG. 1 schematically illustrates, by way of non-limitative example, a compression system according to one embodiment of the invention.

The system comprises several compressors C1, C2, C3 and C4 in series (four compressors here, but the system could have a different number of compressors).

Compressors C1, C2, C3 and C4 enable gradual rise in pressure of a fluid stream 10 comprising at least 80% carbon dioxide. This fluid may notably come from the gas exhaust of a combustion chamber or from any other industrial equipment producing carbon dioxide with potentially up to 20% impurities. Thus, from upstream in the direction of flow of the fluid, the fluid is first compressed in compressor C1, then in compressor C2 and in compressor C3, and finally in compressor C4. At the outlet of the last compressor C4 through which the fluid stream passes, the fluid reaches the desired pressure, between 8 and 50 bar, i.e. between 0.8 and 5 MPa (50 bar, i.e. 5 MPa, excl.).

Compressors C1, C2, C3 and C4 are separated by coolers, here in form of first heat exchangers without direct contact R1, R2 and R3 (so as not to modify the fluid composition). Gas/liquid separators (not shown) may also be provided just after each cooler R1, R2 and R3 to eliminate the condensed fluid in the liquid state, prior to reaching the next compressor C2, C3 or C4.

What is meant by heat exchangers without direct contact or with indirect contact is that the fluid exchanges heat with a heat-transfer fluid without direct contact between the fluid and the heat-transfer fluid: for example, this heat exchange without direct contact can occur through a wall, the fluid being on one side of the wall and the heat-transfer fluid on the other side thereof. This may notably be the case with a tube or plate exchanger.

Coolers R1, R2 and R3 allow the fluid temperature to be maintained at a predetermined value, between 10° C. and 100° C. for example.

The assembly made up of compressors C1, C2, C3 and C4 and of first heat exchangers without direct contact R1, R2 and R3 forms a compression device 15.

At the outlet of compression device 15 (therefore of last compressor C4), the fluid enters a first cooling means 20 for partly liquefying the fluid. This cooling means can be a heat exchanger, preferably without direct contact.

Thus, the fluid is cooled and partly liquefied. When leaving the first cooling means, the fluid comprises a portion of gas and a portion of liquid. It is thus a multiphase fluid and it can pass into multiphase pump 30 that will allow a pressure increase to a predetermined value below the critical pressure of the fluid. When using a multiphase pump 30, the inlet fluid can be carbon dioxide with a high level of impurities (between 5% and 20% impurities for example), which makes it possible to avoid fluid pretreatment devices at the inlet. Furthermore, these impurities may notably be noncondensible gases since the multiphase pump is designed to accept a high proportion of gas (at least 50%, preferably ranging between 75% and 95%).

The compressed multiphase fluid is then cooled in a second cooling means 40 such as a heat exchanger, to a predetermined temperature preferably ranging between 0° C. and 60° C. so as to totally liquefy the carbon dioxide of the fluid. This second cooling means 40 is however optional. At the outlet of second cooling means 40, the fluid comprises only carbon dioxide in liquid form. It is then sent into a supercritical pump 60 to reach the critical pressure and thus change to the supercritical state 10′, in which it can subsequently be transported through transport pipes for example, and stored in a geological or artificial reservoir.

Optionally, a gas/liquid separation means (gas/liquid separator for example) can be positioned between second cooling means 40 and supercritical pump 60 so as to eliminate the gas or to reduce the amount of gas contained in the fluid to a volume fraction below 5%, in order to facilitate the operation of supercritical pump 60 and to improve the performances thereof.

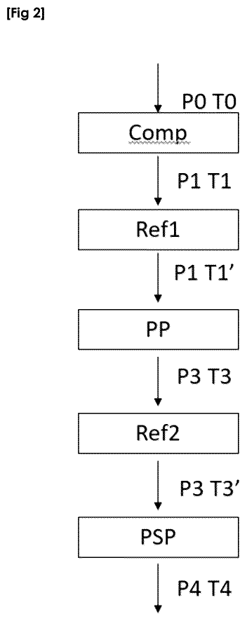

FIG. 2 schematically illustrates, by way of non-limitative example, a compression method according to the invention.

The fluid comprising at least 80% carbon dioxide flows at a pressure P0 (between 1 and 3 bar for example) and at a temperature T0 (between 10° C. and 50° C. for example) into a compression device comprising one or more compression stages. The fluid is then compressed Comp to a pressure P1 (greater than 8 bar and strictly less than 50 bar) and a temperature T1 (between 10° C. and 100° C. for example). The fluid is then cooled Ref1 so as to undergo partial liquefaction. After step Ref1, the fluid is a multiphase fluid comprising both a gas portion and a liquid portion, and it is at pressure P1 and a temperature T1′ (between −50° C. and 15° C. for example) below T1.

The fluid being then multiphase, it can be compressed in a multiphase pump PP which it leaves at pressure P3 (for example between 65 and 100 bar, i.e. between 6.5 and 10 MPa) and at temperature T3 (between 0° C. and 60° C. for example). Pressure P3 is strictly less than the critical pressure of the fluid so as to avoid transition to the supercritical state in the multiphase pump.

At the outlet of multiphase compression PP, the fluid is optionally cooled Ref2 to totally liquefy at least the carbon dioxide contained in the fluid. It thus flows therefrom at pressure P3 and at a temperature T3′ below T3.

If need be, the fluid can then be separated in a gas/liquid separation means in order to reduce the gas fraction to a value below 5%. This step is particularly advantageous when the fluid comprises more than 5% noncondensible gas.

The fluid, either flowing directly from cooling step Ref2 as illustrated or from the optional gas/liquid separation step, is then compressed in a supercritical pump PSP where it changes to the supercritical state. It flows out in the supercritical state at a pressure P4 (for example between 74 and 200 bar, i.e. between 7.4 and 20 MPa) greater than the critical pressure of the fluid, and at temperature T4.

It can then be transported and stored for example in an artificial or geological reservoir.

FIG. 3 schematically illustrates, by way of non-limitative example, a comparison between the thermodynamic paths (a) and (b) of two carbon dioxide compression methods according to the prior art and a thermodynamic path (c) of a compression method for a fluid comprising at least 80% carbon dioxide according to the invention.

Thermodynamic path (a) is shown by the solid line arrows, thermodynamic path (b) is shown by the dashed line arrows and thermodynamic path (c) is shown by the dash-dotted line arrows.

For thermodynamic paths (b) and (c), the first part of the path is identical to thermodynamic path (a), and only the part of the path that deviates from thermodynamic path (a) is shown by the dashed line arrows or the dash-dotted line arrows.

Thermodynamic path (a) corresponds to the thermodynamic path of patent application WO-2011/101,296 of the prior art, while thermodynamic path (b) corresponds to the thermodynamic path of patent application JP-2010/266,154 of the prior art.

Thermodynamic path (a) is characterized by a succession of compressions followed by cooling, where the fluid is maintained in the gaseous state (to the right and outside of the envelope characterized by fluid saturation curve 50).

Once the fluid in gas form (with no liquid portion) reaches a pressure (point 54) greater than the pressure of critical point 52, the fluid is cooled to point 57. It is then compressed to the desired transport pressure P4 (point 58).

Thermodynamic path (b) is characterized by a succession of compressions followed by cooling, where the fluid is maintained in the gaseous state (to the right and outside of the envelope characterized by fluid saturation curve 50) up to a pressure P2 (point 53) below the pressure of critical point 52. In this part, thermodynamic path (b) is substantially identical to thermodynamic path (a).

From point 53, the fluid is cooled so as to be totally liquefied and to reach point 55 on saturation curve 50, or slightly to the left of saturation curve 50.

Thus, at point 55, the fluid is totally liquid.

It is subsequently compressed to pressure P4 of point 61 where it changes to the supercritical state.

Thermodynamic path (c) is characterized by a succession of compressions followed by cooling, where the fluid is maintained in the gaseous state (to the right and outside of the envelope characterized by fluid saturation curve 50) up to a pressure P1 (point 51) below the pressure of critical point 52. In this part, thermodynamic path (c) is substantially identical to thermodynamic path (a).

From point 51, the fluid is cooled so as to be partly liquefied and to reach point 62 located below saturation curve 50 (in the envelope defined by saturation curve 50). The fluid being located below saturation curve 50 (in the envelope defined by saturation curve 50), it is a multiphase fluid comprising both a gas portion and a liquid portion.

It is then compressed by a multiphase pump to a pressure P3 (point 63) below the pressure of critical point 52 so as to remain in the multiphase state in the multiphase pump and to avoid changing to the supercritical state in this multiphase pump.

It is then cooled to reach total liquefaction of at least the carbon dioxide of the fluid at point 56 located on saturation curve 50 or slightly to the left of saturation curve 50. Thus, at point 56, the fluid (at least the carbon dioxide of the fluid) is totally liquid.

It is subsequently compressed to pressure P4 of point 59 using a supercritical pump and it changes to the supercritical state.

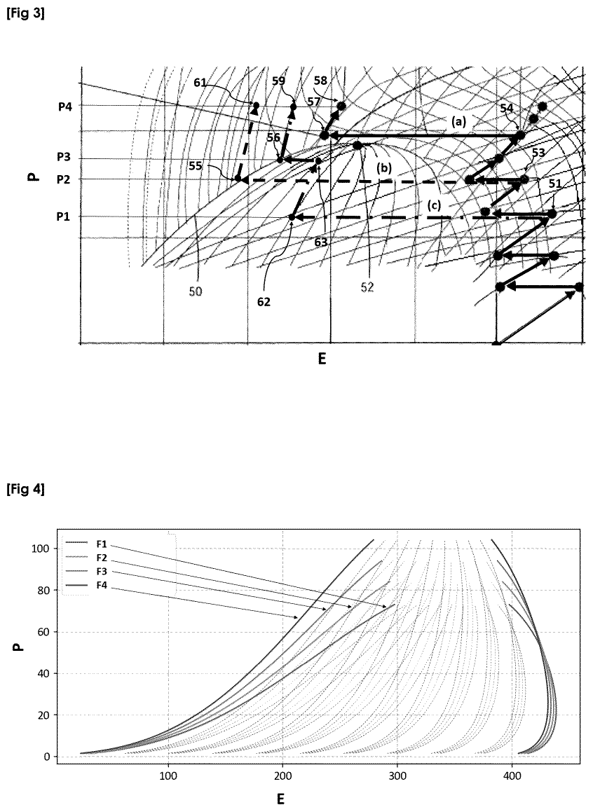

FIG. 4 schematically illustrates, by way of non-limitative example, the modifications in the thermodynamic properties of the fluid according to the level of impurities contained in the carbon dioxide.

The graph shows, on the y-axis, pressure P of the fluid (in bar, 1 bar equals 0.1 MPa) and, on the x-axis, the enthalpy (in kJ/kg).

The various curves F1, F2, F3, F4 are the saturation curves of several fluids:
F1 is the saturation curve of a fluid containing 100% carbon dioxide
F2 is the saturation curve of a fluid containing 95% carbon dioxide and 5% dinitrogen
F3 is the saturation curve of a fluid containing 90% carbon dioxide and 10% dinitrogen
F4 is the saturation curve of a fluid containing 85% carbon dioxide and 15% dinitrogen.

It is noted that the more the rate of impurities (dinitrogen here) increases, the more the envelope of the saturation curve increases and the more the critical pressure increases, from 74 bar (7.4 MPa) for pure carbon dioxide to more than 100 bar (more than 10 MPa) for carbon dioxide with 15% dinitrogen.

For optimization of the method and the system, the real critical pressure of the fluid can thus be taken into account in order to improve the efficiency and the performances of the method and the system.

### EXAMPLES

Various compression methods of the invention were dimensioned for the compression of pure carbon dioxide, and these methods of the invention were subsequently compared.

For dimensioning of these various compression methods of the invention, the inlet fluid is pure carbon dioxide (with no impurities) at a mass flow rate of 156.43 kg/s, an inlet pressure of 0.15 MPa, an inlet temperature of 35° C. and an outlet pressure of 15.3 MPa.

The table hereafter (Table 1) gives the various pressure and temperature values corresponding to thermodynamic path (c) of FIG. 3, and characteristics of the associated compression system, with 1 bar equivalent to 0.1 MPa.

TABLE 1

| | | | | | | | | |
|---|---|---|---|---|---|---|---|---|
| Compression | Pressure P1 | 8 | 8 | 15 | 15 | 15 | 40 | 40 |
| step a) | at the | | | | | | | |
| | compression | | | | | | | |
| | stages | | | | | | | |
| | outlet (bar) | | | | | | | |
| | Number of | 3 | 3 | 4 | 4 | 4 | 6 | 6 |
| | compressors | | | | | | | |
| | Number | 2 | 2 | 3 | 3 | 3 | 5 | 5 |
| | of third | | | | | | | |
| | cooling means | | | | | | | |
| | separating the | | | | | | | |
| | compressors | | | | | | | |
| | Power | 19.9 | 19.9 | 28.7 | 28.7 | 28.7 | 40.9 | 40.9 |
| | consumption | | | | | | | |
| | during | | | | | | | |
| | compression | | | | | | | |
| | step a) (MW) | | | | | | | |
| Steps b) | Temperature | −45.8 | −45.8 | −26.9 | −26.9 | −26.9 | 5.1 | 5.1 |
| and c) | T2 (° C.) at | | | | | | | |
| | the first | | | | | | | |
| | cooling | | | | | | | |
| | means outlet | | | | | | | |
| | Gas volume | 92 | 88 | 85 | 82 | 78 | 63 | 52 |
| | fraction at | | | | | | | |
| | the multiphase | | | | | | | |
| | pump inlet (%) | | | | | | | |
| | Power | 65.0 | 48.9 | 32.2 | 41.1 | 32.5 | 33.5 | 34.6 |
| | consumed | | | | | | | |
| | by the first | | | | | | | |
| | cooling | | | | | | | |
| | means (MW) | | | | | | | |
| | Pressure P3 | 70.6 | 70.6 | 69.8 | 69.5 | 71.0 | 70.1 | 69.3 |
| | at the | | | | | | | |
| | multiphase | | | | | | | |
| | compression | | | | | | | |
| | outlet (bar) | | | | | | | |
| | Number of | 6 | 6 | 4 | 4 | 4 | 2 | 2 |
| | multiphase | | | | | | | |
| | compression | | | | | | | |
| | stages | | | | | | | |
| | Number of | 3 | 0 | 2 | 1 | 0 | 1 | 0 |
| | cooling stages | | | | | | | |
| | between the | | | | | | | |
| | multiphase | | | | | | | |
| | compression | | | | | | | |
| | stages | | | | | | | |
| | Power | 11.9 | 8.1 | 7.8 | 6.6 | 5.4 | 2.4 | 2.3 |
| | consumed | | | | | | | |
| | by the | | | | | | | |
| | multiphase | | | | | | | |
| | pump (MW) | | | | | | | |
| Step e) | Pressure P5 | 153 | 153 | 153 | 153 | 153 | 153.3 | 153 |
| | at the | | | | | | | |
| | supercritical | | | | | | | |
| | pump | | | | | | | |
| | outlet (bar) | | | | | | | |
| | Power | 3.0 | 2.2 | 2.2 | 2.2 | 2.2 | 2.2 | 2.2 |
| | consumed | | | | | | | |
| | by the | | | | | | | |
| | supercritical | | | | | | | |
| | pump (MW) | | | | | | | |
| TOTAL | Total power | 99.8 | 79.1 | 70.9 | 78.6 | 68.8 | 79.0 | 80.0 |
| | consumed | | | | | | | |
| | by the | | | | | | | |
| | compression | | | | | | | |
| | method (MW) | | | | | | | |

These examples show that the method and the system according to the invention allow compression of a fluid comprising carbon dioxide with a low total power consumption (below 100 MW). The most advantageous thermodynamic path, in terms of total energy consumption, is the one corresponding to the column in italics and in a larger font size in Table 1. Indeed, the total energy consumption power is 68.8 MW, whereas the other thermodynamic paths consume between 70.9 MW and 99.8 MW. This embodiment can thus be considered as one of the preferred embodiments of the invention.

For this preferred compression method (column in italics in Table 1), the pressure at the outlet of step a) is 15 bar (1.5 MPa), the pressure at the outlet of multiphase compression step c) is 71 bar, i.e. 7.1 MPa (below the critical pressure of 74 bar, i.e. 7.4 MPa, for pure carbon dioxide), and the gas volume fraction of the fluid at the multiphase pump inlet is 78%.

1. A method for compressing a fluid comprising at least 80% carbon dioxide, the method comprising at least the following steps:
a) compressing (Comp) the fluid in one or more compression stages to a pressure (P1) greater than 8 bar and strictly less than 50 bar,
b) cooling (Ref1) the compressed fluid to a temperature (T1′) of between −50° C. and 15° C., fluid pressure (P1) being maintained greater than 8 bar and strictly less than 50 bar, so as to partly liquefy the carbon dioxide of the fluid, the gas volume fraction of the fluid ranging between 1% and 99%,
c) carrying out multiphase compression (PP) of the cooled compressed fluid to a pressure (P3) strictly below the critical pressure of the fluid, multiphase compression being carried out in one or more multiphase compression stages,
d) preferably cooling (Ref2) the fluid from the multiphase compression so as to totally liquefy at least the carbon dioxide of the fluid,
e) compressing (PSP) the fluid so that the pressure (P4) of the fluid exceeds the critical point of the fluid, preferably to a temperature below 60° C.

2. A method as claimed in claim 1, wherein the fluid is compressed (Comp) in step a) using a single integrally-geared compressor.

3. A method as claimed in claim 1, between at least two compression stages in step a), the fluid is cooled so as to be maintained at a temperature of between 10° C. and 100° C.

4. A method as claimed in claim 3 wherein, after cooling the fluid after at least one compression stage in step a), the fluid in the liquid state is separated from the fluid in the gaseous state.

5. A method as claimed in claim 1, wherein multiphase compression (PP) is carried out using a helicoaxial type multiphase pump.

6. A method as claimed in claim 1, wherein multiphase compression PP) is carried out in several multiphase compression stages and the fluid is preferably cooled by coolers, preferably water coolers, between at least two multiphase compression stages.

7. A method as claimed in claim 1, wherein the fluid is carbon dioxide comprising between 0% and 20% impurities.

8. A method as claimed in claim 7 wherein, after step d) of cooling (Ref2) the fluid from multiphase compression (PP), when the impurities contain noncondensible gas, the fluid is treated to reduce the gas volume fraction to a value below 5%, preferably by gas/liquid separation.

9. A method for transport and storage of a fluid comprising at least 80% carbon dioxide, wherein the fluid is compressed according to the compression method as claimed in claim 1, then the fluid is transported to a storage site and it is stored in a storage reservoir of the storage site.

10. A system for compressing a fluid comprising at least 80% carbon dioxide, the compression system successively comprising at least one compression means (C1, C2, C3, C4), a first cooling means (20) for partly liquefying the fluid, a multiphase pump (30), a second cooling means (40) for totally liquefying the fluid, and a supercritical pump (60), compression means (C1, C2, C3, C4) preferably consisting of a single integrally-geared compressor, the system being suited for implementing the method as claimed in claim 1.

11. A compression system as claimed in claim 10, wherein the system comprises several compression means (C1, C2, C3, C4), and third cooling means (R1, R2, R3), possibly followed by gas/liquid separators, are preferably arranged between the compression means.

12. A compression system as claimed in claim 10, wherein the system comprises at least one gas/liquid separation means preferably positioned between second cooling means (40) and supercritical pump (60).
